(19) United States
(12) Patent Application Publication
(10) Pub. No.: US 2007/0150168 A1
(43) Pub. Date: Jun. 28, 2007

(54) Traffic channel

(75) Inventors: Douglas W. Balcom, Seattle, WA (US); Christian Colando, Seattle, WA (US); Mingyu Tang, Bellevue, WA (US); Albert W. Tan, Redmond, WA (US); Vasantha Badari Kostojohn, Seattle, WA (US); Kent H. Skinner, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/299,560

(22) Filed: Dec. 12, 2005

(51) Int. Cl. G06F 19/00

(52) U.S. Cl. 701/117

(57) ABSTRACT

A method and system for implementing a traffic channel is described herein. A traffic route with a start location and an end location is selected by a user. A plurality of intermediate traffic locations along the traffic route is displayed. The user selects one or more of the displayed intermediate traffic locations. The selected traffic locations are stored for the selected traffic route. Traffic information corresponding to the selected traffic locations for the selected traffic route may then be displayed.

### BACKGROUND

Traffic information is important to many commuters. Some commuters obtain traffic information via the radio, but this information is not targeted for any specific route, and commuters may not get the desired information for the route they are interested in at the time they need it. Some commuters get their traffic information via a web site, such as their state's Department of Transportation website. However, the traffic information on these websites is not targeted to any specific commuter and finding the information for the route that you are interested in may be a slow and cumbersome process. It is difficult for commuters to obtain the traffic information that they desire quickly and efficiently.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to methods and systems for implementing a traffic channel. In accordance with one implementation of the described technologies, a user uses a configuration module to select a traffic route that includes a start location and an end location. A plurality of intermediate traffic locations along the selected traffic route may then be displayed for the user. Each displayed traffic location may correspond to one or more traffic sensors. The user may then select one or more of the displayed traffic locations that the user is interested in obtaining traffic information for. The selected traffic locations are stored for the selected traffic route. Traffic information for the selected traffic locations of the selected traffic route may then be displayed for the user. The traffic information may include a name of the location, a speed at the location, whether the speed is increasing, decreasing, or remaining the same, traffic incidents along the traffic route, and/or any other traffic information.

In another implementation of the described technologies, a user selects one or more traffic regions that the user is interested in obtaining traffic incident information for. Information concerning any traffic incidents in the selected regions may then be displayed for the user. The traffic incident information displayed may include the location of the traffic incident, the type of traffic incident, an approximate time for the traffic incident to clear, and/or any other information about the traffic incident.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating an exemplary system for a traffic channel.

FIG. 2 is a block diagram illustrating another exemplary system for a traffic channel.

FIG. 3 is a flow diagram illustrating an exemplary process for displaying traffic information for selected traffic locations along a traffic route.

FIG. 4 is a flow diagram illustrating an exemplary process for displaying speed indicators at selected traffic locations along a traffic route.

FIG. 5 is a flow diagram illustrating an exemplary process for displaying traffic incidents at selected traffic regions.

FIG. 6 is a screenshot illustrating an exemplary user interface for displaying selected traffic routes and traffic incident regions.

FIG. 7 is a screenshot illustrating an exemplary user interface for selecting a traffic route and intermediate locations along a traffic route.

FIG. 8 is a screenshot illustrating an exemplary user interface for selecting traffic incident regions.

FIGS. 9A-9D are screenshots illustrating exemplary user interfaces for displaying traffic information for a selected traffic route.

FIGS. 10A-10E are screenshots illustrating exemplary user interfaces for displaying incident information for selected traffic regions.

FIG. 11 illustrates an exemplary computing environment in which certain aspects of the invention may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

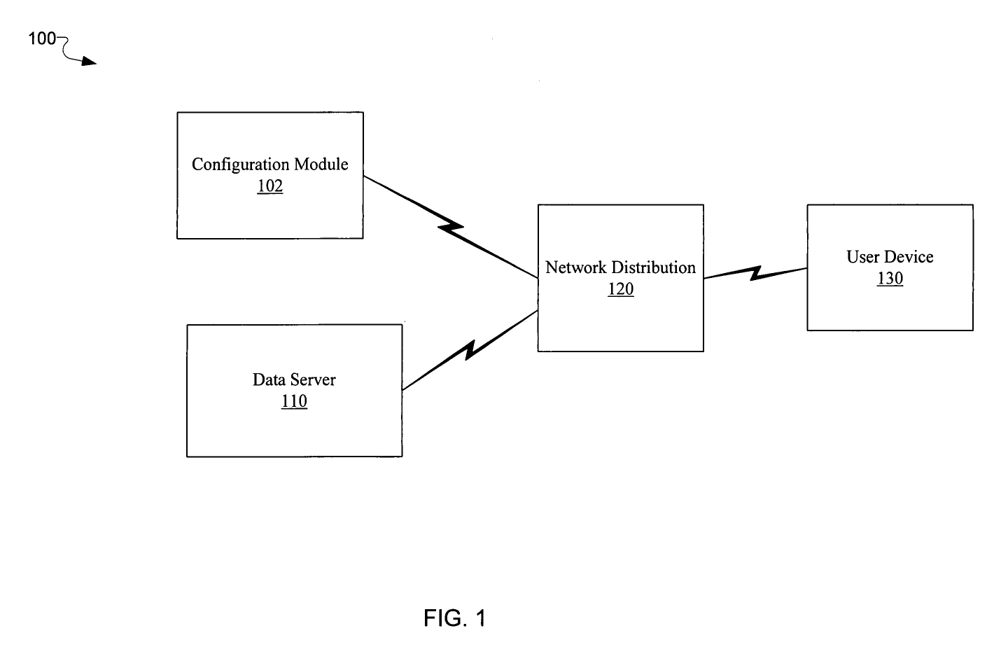

FIG. 1 is a block diagram illustrating an exemplary system 100 for a traffic channel. System 100 includes a configuration module 102 to configure the traffic routes and traffic incident regions. A user may use the configuration module 102 to select one or more traffic routes and one or more traffic incident regions. The user's selections are stored. Data server 110 collects and stores traffic data for a plurality of locations. These locations may correspond to one or more traffic sensors. Network distribution element 120 uses the user's traffic route selections to determine what traffic data to distribute to the user device 130. When the user device 130 receives the traffic data, the user device 130 may process the traffic data and display the traffic information for the user. Examples of user devices include but are not limited to a computing device, a mobile device, or a wearable device, such as a watch.

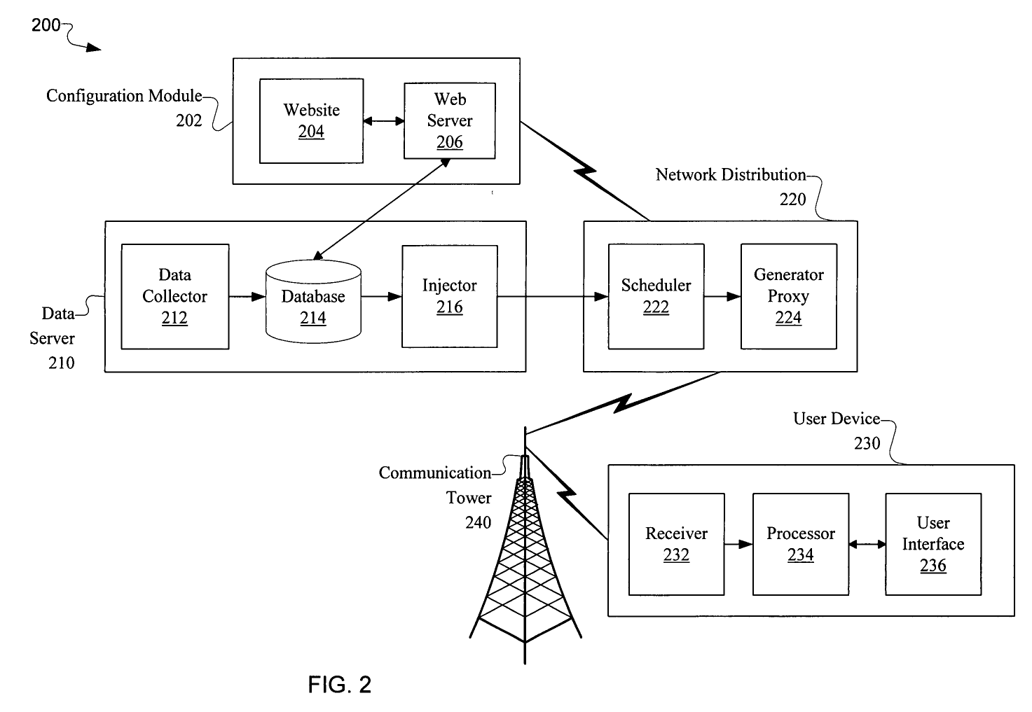

FIG. 2 is a block diagram illustrating another exemplary system 200 for a traffic channel. In this exemplary system 200, a user logs onto a website 204 to select one or more traffic routes that the user is interested in. The website is part of a configuration module 202 that provides a user interface to allow the user to select a start location and an end location for the traffic route. The website may then show the user one or more intermediate locations along the traffic route. The user may select one or more of the displayed intermediate locations. The user's selections are stored in a database via web server 206. In this example, the user's selections are stored in database 214, which is part of data server 210. Alternatively, the configuration module 202 may have its own database for storing the user's selections. Traffic information corresponding to the user's selected traffic route may then be displayed on a user device 230.

Data server 210 includes a data collector 212 that collects traffic data for a plurality of locations. This data may be collected from sources that provide traffic data corresponding to traffic sensors, such as sensors monitored by a state's Department of Transportation. The traffic data may include but is not limited to speed of traffic, accidents, construction, stalls, road blocks, and road closures. The collected traffic data is stored in database 214. Injector 216 transforms data from database 214 into a format for broadcasting. The transformed data may be temporarily stored in a memory. The transformed traffic data may then be distributed via scheduler 222 to the appropriate region. The scheduler 222 may decide when and where the transformed traffic data is to be broadcasted. The network distribution module 220 has a generator proxy 224 to help prepare the traffic data for broadcasting and send the traffic data to a communication tower 240. For example, the generator may convert the traffic data to a binary format for broadcasting before sending the data to the communication tower 240. The user device 230 receives the traffic data from the communication tower 240 via receiver 232 and processes the data via processor 234. Traffic information is then displayed for the user via the user interface 236.

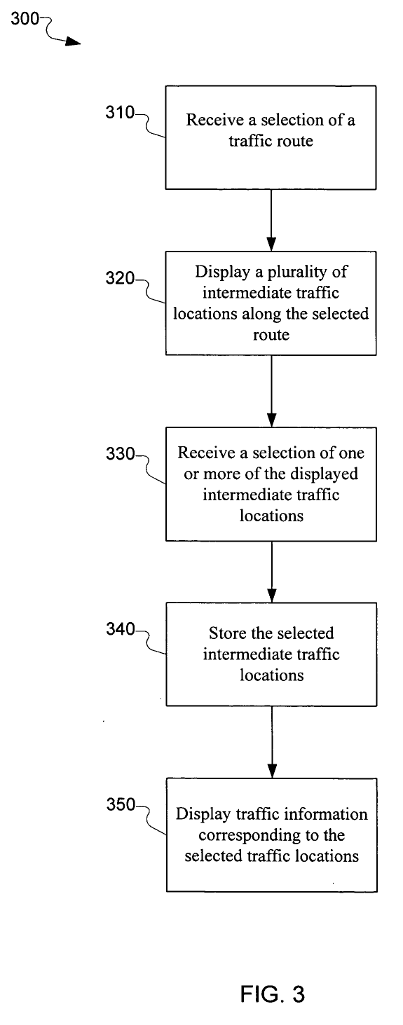

FIGS. 3-5 are flow diagrams illustrating exemplary processes of the traffic channel. While the descriptions of FIGS. 3-5 may be made with reference to other figures, it should be understood that the exemplary processes illustrated in FIGS. 3-5 are not intended to be limited to being associated with the systems or other contents of any specific figure or figures. Additionally, it should be understood that while the exemplary processes of FIGS. 3-5 indicate a particular order of operation execution, in one or more alternative implementations, the operations may be ordered differently. Furthermore, some of the steps and data illustrated in the exemplary processes of FIGS. 3-5 may not be necessary and may be omitted in some implementations. Finally, while the exemplary processes of FIGS. 3-5 contain multiple discrete steps, it should be recognized that in some environments some of these operations may be combined and executed at the same time.

FIG. 3 is a flow diagram illustrating an exemplary process 300 for displaying traffic information for selected traffic locations along a traffic route. At 310, the configuration module receives a selection of a traffic route by a user. This selection of a traffic route includes a start location and an end location. At 320, a plurality of intermediate locations along the traffic route may be displayed. The user may then select one or more of the displayed intermediate locations. At 330, the configuration module receives the user's selections. At 340, the configuration module may store these selections. Traffic data corresponding to the user's selections may then be distributed to the user device. At 350, the user device may display traffic information corresponding to the selected locations along the selected traffic route. The traffic information may include but is not limited to a speed at each selected location, whether the speed is increasing or decreasing, and any traffic incidents along the selected traffic route.

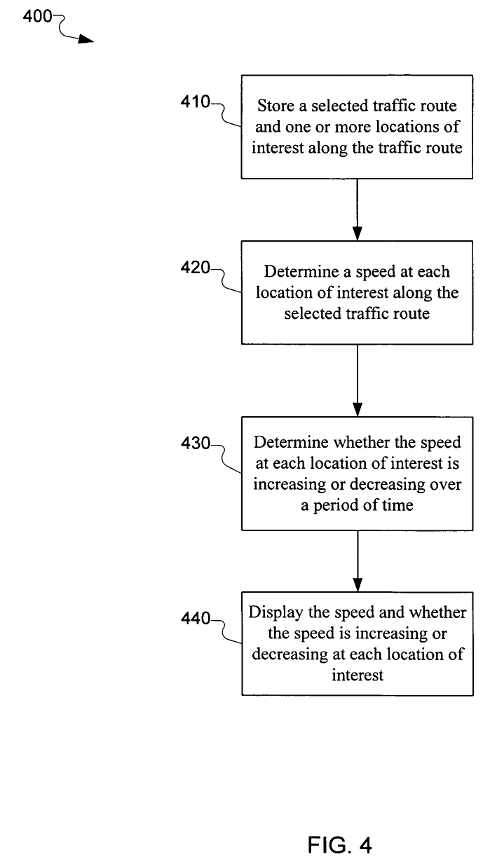

FIG. 4 is a flow diagram illustrating an exemplary process 400 for displaying speed indicators at selected traffic locations along a traffic route. A user selects a traffic route and one or more locations of interest along the traffic route. At 410, the user's selections are stored. At 420, a speed at each location of interest is determined. The speed may be determined from traffic data corresponding to one or more traffic sensors at each location of interest. The current speed may then be compared to a previous speed at the same location. At 430, a determination is made as to whether the speed at each location is decreasing, increasing, or staying the same. At 440, the speed is displayed along with whether the speed is decreasing, increasing, or staying the same. A symbol may be used to represent whether the speed is decreasing, increasing, or staying the same. The period of time in which a speed is updated and compared with a previous speed may be predetermined or selectable. A timestamp may be displayed indicating when the speed was last updated.

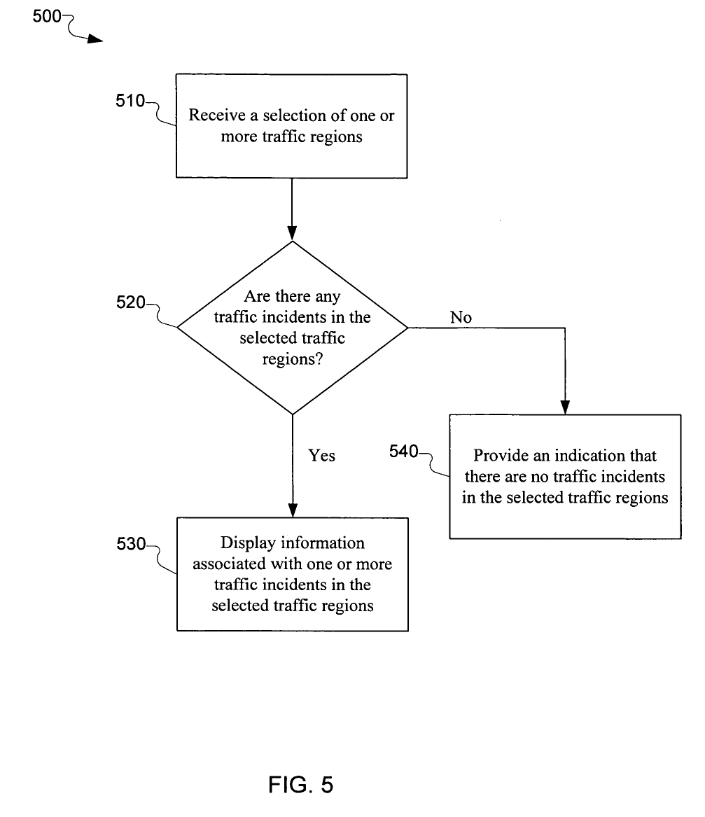

FIG. 5 is a flow diagram illustrating an exemplary process 500 for displaying traffic incidents at selected traffic regions. A user selects one or more traffic regions which the user is interested in receiving traffic incident information about. At 510, the configuration module receives the user's selections. The configuration module may then store the user's selections. At 520, a determination is made as to whether there are any traffic incidents in the selected traffic regions. These traffic incidents may include but are not limited to accidents, stalls, construction, road closures, and blocked roads. If there are any traffic incidents in the selected traffic regions, then at 530, information about these traffic incidents may be displayed for the user. The information displayed may include but is not limited to the location of the traffic incident, the type of traffic incident, and an estimated time for the traffic incident to clear. If there are no traffic incidents in the selected traffic regions, then at 540, this information is conveyed to the user. The words “no incidents” or a corresponding symbol or representation may be displayed to indicate that there are no traffic incidents in the selected traffic region.

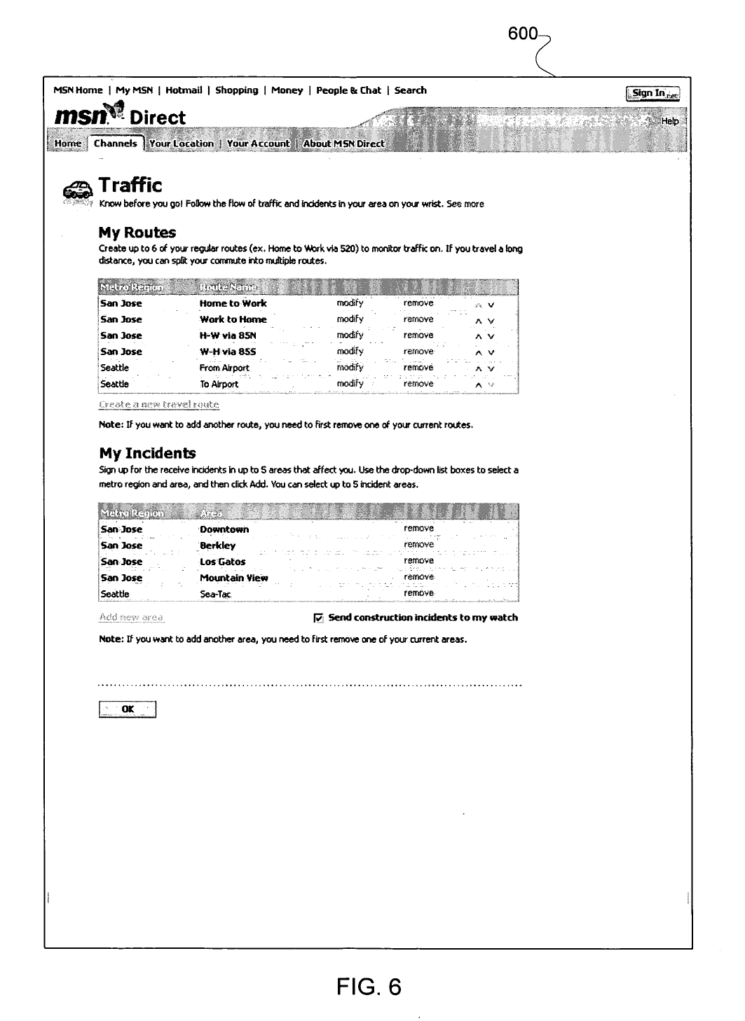

FIG. 6 is a screenshot illustrating an exemplary user interface 600 for displaying selected traffic routes and traffic incident regions. As shown, a user may select one or more traffic routes to monitor traffic on. Each route may have a route name selected by the user and an associated region. From user interface 600, a user may select to add a new route, modify a current selected route, or remove a current selected route. The user may also select one or more traffic regions for which to receive incident information. Then, traffic information corresponding to the selected traffic routes and incident information corresponding to the selected traffic regions may be sent to a user device, such as a watch or a computing device.

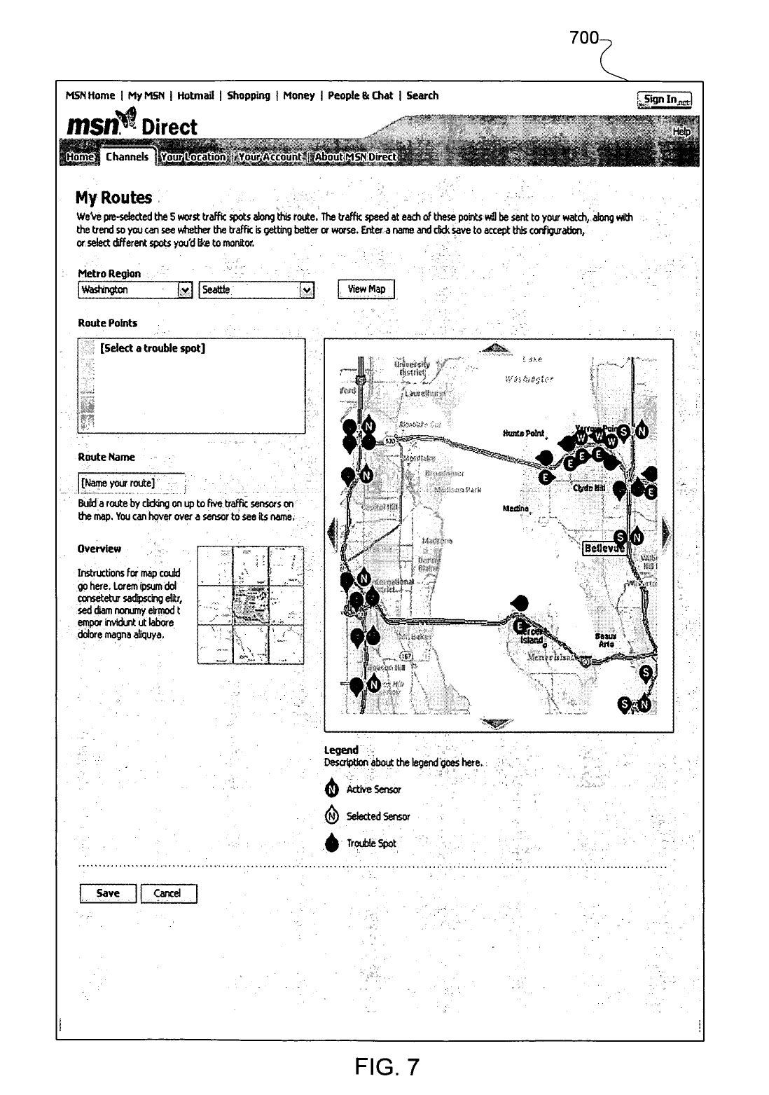

FIG. 7 is a screenshot illustrating an exemplary user interface 700 for selecting a traffic route and intermediate locations along a traffic route. A user may first select a region, a starting location, and an end location. After a starting location and end location is selected, the configuration module may pre-select one or more intermediate locations along the traffic route that may represent locations that typically have congestion problems. These trouble spots may be shown on a map along with other intermediate locations that may be chosen by the user. Different symbols may be used to represent whether an intermediate location is a trouble spot, a selected location, or a location with an active traffic sensor. After the user selects one or more intermediate locations, the selections for the chosen traffic route may be saved. There may be a predetermined limit on the number of locations a user may select.

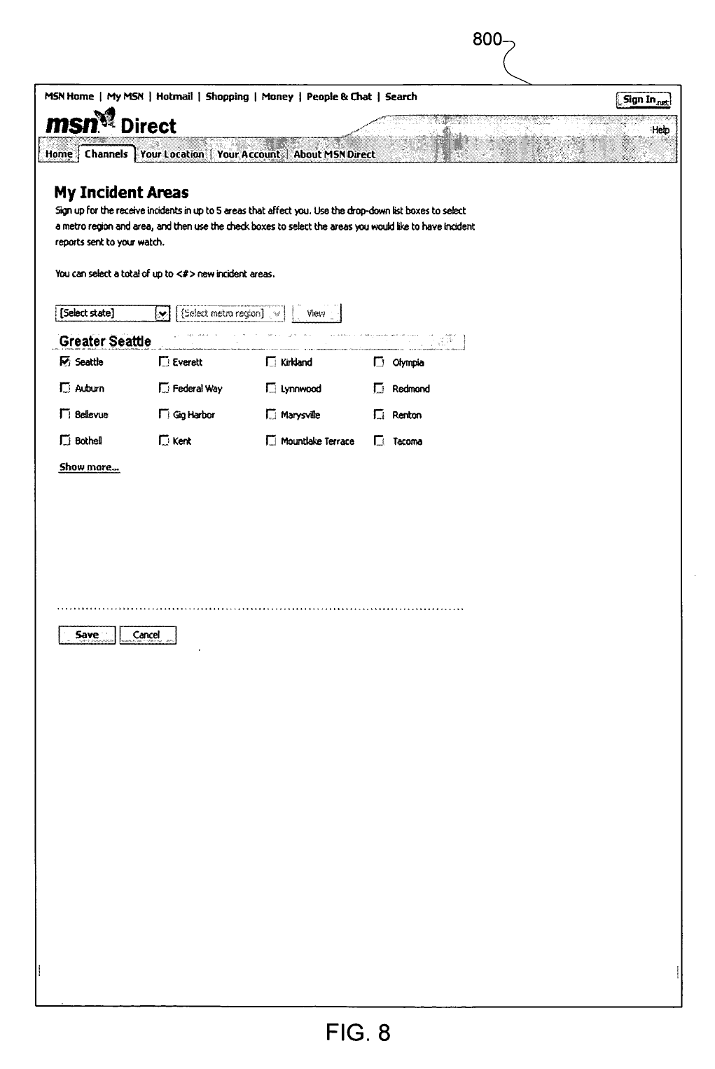

FIG. 8 is a screenshot illustrating an exemplary user interface 800 for selecting traffic incident regions. A user may select a state or area that the user is interested in. The user may then select one or more regions or cities in which to monitor incidents. These selections may then be saved. When there are traffic incidents in the selected regions or cities, information about the incidents may be displayed on a user device, such as a watch or a computing device.

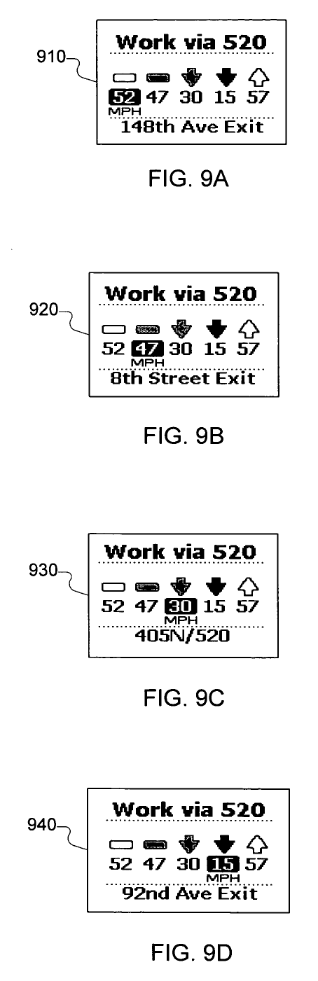

FIGS. 9A-9D show screenshots illustrating exemplary user interfaces 910-940 for displaying traffic information for a selected traffic route on a user device. In this example, the user has selected a traffic route named “Work via 520” and five locations along the traffic route. Traffic information about the five selected locations, such as the speed, may be displayed for the user as shown. A user may scroll from one location to another to see traffic information corresponding to each selected location along the selected traffic route. The traffic information displayed may include the name of the traffic route such as “Work via 520”, the location such as “148^{th} Ave Exit”, a speed at the location such as “52 mph”, and whether the speed at the location is increasing, decreasing, or staying the same. Different symbols may be used to indicate whether the speed is increasing, decreasing, or staying the same. For example, a straight bar icon (such as that shown above the speeds 52 and 47) may indicate that the speed is staying the same. A down arrow (such as that shown above speeds 30 and 15) may indicate that the speed is decreasing. An up arrow (such as that shown above speed 57) may indicate that the speed is increasing. Shading may also be used to identify a range of speeds. For example, no shading may indicate a high speed range, light shading may indicate an intermediate speed range, and dark shading may indicate a low speed range.

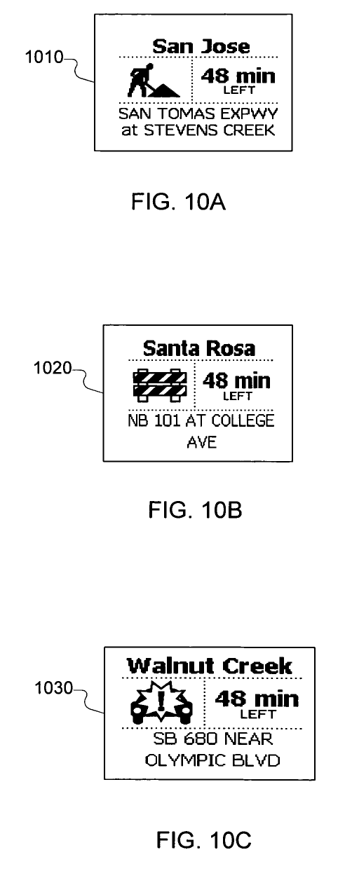

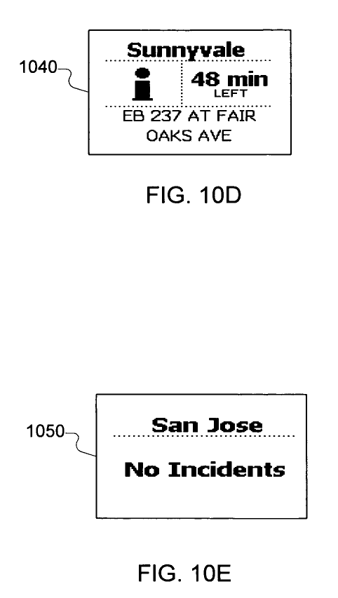

FIGS. 10A-10E are screenshots illustrating exemplary user interfaces 1010-1050 for displaying incident information for selected traffic regions on a user device. The incident information displayed may include but is not limited to the region or city, the location of the incident, the type of incident, and the estimated time to clear the incident. Different symbols may be used to indicate different types of incidents. For example, interface 1010 shows a symbol that may be used for a construction incident, interface 1020 shows a symbol that may be used for a road block, road closure, or jam, interface 1030 shows a symbol that may be used for an accident, stall, or danger incident, and interface 1040 shows a symbol that may be used for a weather incident, a slippery road, a transit incident, a two-way incident, a parking incident, or other informational incident. Interface 1050 may be used to indicate that there are no traffic incidents in the selected region or city.

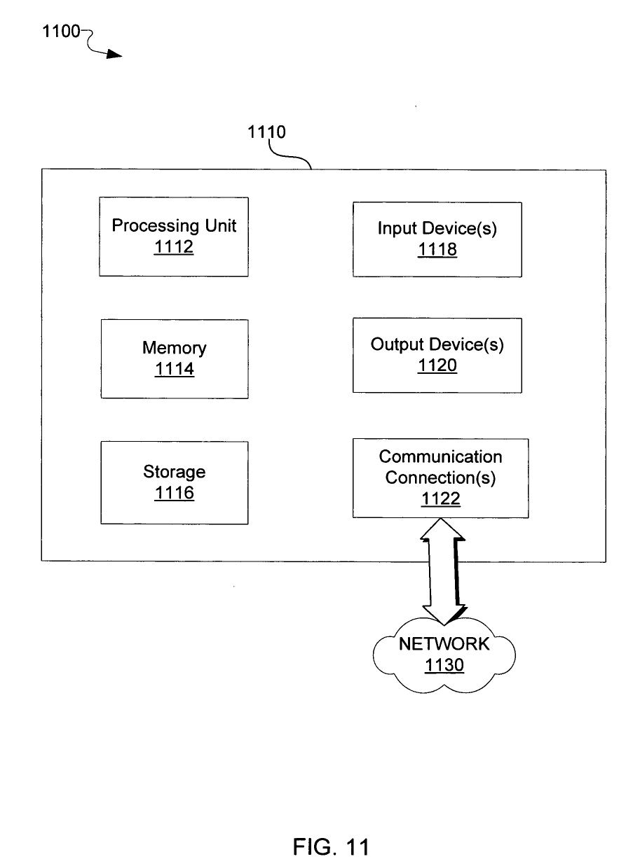

FIG. 11 illustrates an exemplary computing environment in which certain aspects of the invention may be implemented. It should be understood that computing environment 1100 is only one example of a suitable computing environment in which the various technologies described herein may be employed and is not intended to suggest any limitation as to the scope of use or functionality of the technologies described herein. Neither should the computing environment 1100 be interpreted as necessarily requiring all of the components illustrated therein.

The technologies described herein may be operational with numerous other general purpose or special purpose computing environments or configurations. Examples of well known computing environments and/or configurations that may be suitable for use with the technologies described herein include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

With reference to FIG. 11, computing environment 1100 includes a general purpose computing device 1110. Components of computing device 1110 may include, but are not limited to, a processing unit 1112, a memory 1114, a storage device 1116, input device(s) 1118, output device(s) 1120, and communications connection(s) 1122.

Depending on the configuration and type of computing device, memory 1114 may be volatile (such as RAM), non-volatile (such as ROM, flash memory, etc.) or some combination of the two. Computing device 1110 may also include additional storage (removable and/or non-removable) including, but not limited to, magnetic or optical disks or tape. Such additional storage is illustrated in FIG. 11 by storage 1116. Computer storage media includes volatile and nonvolatile, removable and non-removable media implemented in any method or technology for storage of information such as computer readable instructions, data structures, program modules or other data. Memory 1114 and storage 1116 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1110. Any such computer storage media may be part of computing device 1110.

Computing device 1110 may also contain communication connection(s) 1122 that allow the computing device 1110 to communicate with other devices, such as with other computing devices through network 1130. Communications connection(s) 1122 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes storage media.

Computing device 1110 may also have input device(s) 1118 such as a keyboard, a mouse, a pen, a voice input device, a touch input device, and/or any other input device. Output device(s) 1120 such as one or more displays, speakers, printers, and/or any other output device may also be included.

While the invention has been described in terms of several exemplary implementations, those of ordinary skill in the art will recognize that the invention is not limited to the implementations described, but can be practiced with modification and alteration within the spirit and scope of the appended claims. The description is thus to be regarded as illustrative instead of limiting.

1. A method comprising:
receiving a selection of a traffic route, the traffic route having a start location and an end location;
displaying a plurality of intermediate traffic locations along the selected traffic route, each intermediate traffic location corresponding to one or more traffic sensors along the selected traffic route;
receiving a selection of one or more of the plurality of displayed intermediate traffic locations along the selected traffic route;
storing the selected intermediate traffic locations for the selected traffic route; and
displaying traffic information corresponding to the selected traffic locations for the selected traffic route.

2. The method of claim 1, wherein receiving the selection of the traffic route comprises receiving a selection of a first city for a start location of the traffic route and receiving a selection of a second city for an end location of the traffic route.

3. The method of claim 1, wherein displaying a plurality of intermediate traffic locations along the traffic selected route comprises displaying on a website a plurality of intermediate traffic locations along the traffic selected route.

4. The method of claim 1, wherein displaying traffic information corresponding to the selected traffic locations for the selected traffic route comprises displaying on a mobile device traffic information corresponding to the selected traffic locations for the selected traffic route.

5. The method of claim 1, wherein displaying traffic information corresponding to the selected traffic locations for the selected traffic route comprises displaying on a website traffic information corresponding to the selected traffic locations for the selected traffic route.

6. The method of claim 1, wherein displaying traffic information corresponding to the selected traffic locations for the selected traffic route comprises displaying on a watch traffic information corresponding to the selected traffic locations for the selected traffic route.

7. The method of claim 1, wherein displaying traffic information corresponding to the selected traffic locations for the selected traffic route comprises displaying one or more traffic incidents along the selected traffic route.

8. The method of claim 1, wherein displaying traffic information corresponding to the selected traffic locations for the selected traffic route comprises displaying a speed at each selected traffic location for the selected traffic route.

9. The method of claim 1, further comprising receiving a selection of one or more traffic regions and displaying one or more traffic incidents in the one or more selected traffic regions.

10. A system comprising:
a storage module to store traffic information for a plurality of traffic locations, each traffic location corresponding to one or more traffic sensors;
a configuration module to receive from a user a selection of a traffic route and one or more of the plurality of stored traffic locations along the selected traffic route; and
a network distribution element communicatively coupled to the configuration module and the storage module to distribute to a user device traffic information that corresponds to the selected traffic locations along the selected traffic route.

11. The system of claim 10, wherein the network distribution element comprises a scheduler to schedule the distribution of traffic data to the user device.

12. The system of claim 10, further comprising a data collection element coupled to the storage module to determine and update the traffic information stored in the storage module based on data from the corresponding traffic sensors.

13. The system of claim 10, wherein the configuration module includes a website to display and receive traffic route selections.

14. One or more device-readable media including device-executable instructions for performing the following:
storing a selected traffic route and one or more locations of interest along the traffic route;
determining a speed at each location of interest along the selected traffic route;
determining whether the speed at each location of interest is increasing or decreasing over a period of time; and
displaying the speed at each location of interest and whether the speed is increasing or decreasing at each location of interest along the selected traffic route.

15. The one or more device-readable media of claim 14, wherein determining a speed at each location of interest along the selected traffic route comprises determining a speed at each location of interest along the selected traffic route based on one or more traffic sensors at each location of interest.

16. The one or more device-readable media of claim 14, further comprising device-executable instructions for determining whether there are traffic incidents along the selected traffic route.

17. The one or more device-readable media of claim 16, further comprising device-executable instructions for displaying information about one or more traffic incidents along the selected traffic route.

18. The one or more device-readable media of claim 14, wherein displaying the speed at each location of interest and whether the speed is increasing or decreasing at each location of interest along the selected traffic route comprises displaying one of a plurality of different icons based on whether the speed is increasing or decreasing at each location of interest along the selected traffic route.

19. The one or more device-readable media of claim 14, further comprising device-executable instructions for displaying a name of the location of interest.

20. The one or more device-readable media of claim 14, further comprising device-executable instructions for displaying a timestamp indicating when the displayed speed was last updated.
